(19) United States
(12) Patent Application Publication
(10) Pub. No.: US 2007/0224232 A1
(43) Pub. Date: Sep. 27, 2007

(54) COMPOSITION AND METHOD TO REPEL INSECTS

(76) Inventor: JEFFREY SHERWOOD, Ball Ground, GA (US)

Correspondence Address: TROUTMAN SANDERS LLP, 600 PEACHTREE STREET , NE, ATLANTA, GA, 30308, US

(21) Appl. No.: 11/277,573

(22) Filed: Mar. 27, 2006

(51) Int. Cl. A01N 65/00

(52) U.S. Cl. 424/405; 424/725; 424/745; 424/747; 424/750; 424/757

(57) ABSTRACT

The present invention comprises methods and compositions for repelling insects. The compositions and methods comprise combinations of essential oils or materials that can be extracted from essential oils to repel insects. The essential oil blends can be combined with various gellants and used in devices that actively disperse the volatiles throughout an area to prevent or reduce the incidence of annoyance from insects.

### FIELD OF INVENTION

This invention relates to the field of insect repellency. In particular, the invention concerns a composition and a method to efficiently diffuse an essential oil derived insect repellent.

### BACKGROUND

The use of insect repellents and methods to dispense them into the air has been described previously. The usefulness of such devices is quite apparent, as they can provide people and animals with protection from the bites and annoyance of flying insects. Additionally, certain flying insects can spread disease if not repelled by an effective repellent system.

In an attempt to meet the consumer demand for insect repellency many devices and methods have been developed to prevent flying insects from interacting with people and animals. Many of these devices volatilize effective amounts of insect repellents into the air. Examples of these devices and methods are found in U.S. Pat. Nos. 5,645,845, 6,033,212, 6,183,200, 6,293,044, 6,361,752, 6,362,235 6,391,329, 6,447,795, U.S. patent applications 2002/0005437, 2003/0017178, 2003/0061759, and European patent application EP 1 029 0451.

Essential oils and materials derived from essential oils have been used in insect repellants previously. Traditionally, citronella has been used to repel insects when diffused into the air from candles and oil burning lamps. Recent publications (U.S. patent application 2002/0005437) cast doubt on the effectiveness of citronella by itself. U.S. patent application 2003/0017178 uses essential oils to fragrance and to produce some insect repellency, but must be used in combination with non-insect repellants to be effective. Additionally, there is no indication that the insect repellency of this composition has effectiveness as a broad area repellent after diffusing it into the air. The use of a variety of essential oils to repel insects is described in US patent application 2003/0026823. However these essential oils must be combined with aldehyde C-14 and aldehyde C-18 to be effective. Essential oil use is described in U.S. Pat. No. 6,548,085 but the addition of a synergist of sodium laural sulfate or lecithin is required for the essential oils to be effective. The use of the extract from Tarchonanthus camphorates to provide insect repellency has been described in WO 03/055316. This extract must, however, be used with a triglyceride to be effective.

Topical pest repellants have been described using citronella, cedar and wintergreen or pennyroyal in a non-toxic carrier. No indication of any effectiveness is indicated for the airborne use of this mixture.

No blend of essential oils or essential oil derived materials found in the present invention has been described previously. No composition of essential oils or essential oil derived materials have been used in the inventive method described herein to diffuse the essential oils, such as into the air, in an effective manner to repel insects.

### SUMMARY OF THE INVENTION

The present invention relates to the compositions and methods for repelling insects by the means of diffusing insect repellent compositions of essential oils or essential oil derived materials, for example, into the air. The compositions for repelling insects may comprise four or more essential oils or materials that can be extracted from essential oils, without the requirement of synergists or other added chemicals for effectiveness. In a preferred embodiment of the invention a composition is comprised of four or more from the following group: citral, citronella oil, cedarwood oil, mint oil, commint oil, peppermint oil, mentha citrate oil, lemongrass oil, geraniol, and geranium oil. The composition of the present invention may comprise essential oils or materials that may be derived from essential oils in any combination. For example, a composition may comprise at least one essential oil and three essential oil derived materials, or the composition may include at least four essential oils, and so on.

The composition containing the essential oils and essential oil derived materials may be combined and mixed with a gellant to form a gel or used as a liquid. The insect repellant composition of the present invention can be placed in a device that contains an active diffusion means to actively disperse the composition into the air. The composition is placed into a device that will add energy to the essential oil composition causing it to diffuse from the device into the surrounding air. The presence of the composition in the air repels flying insects including mosquitoes and flies. The energy that is added to the composition for dispersion is typically from a fan and/or heater. The use of a combination of a fan and a heater is a preferred method to diffuse the composition of the present invention.

The composition may also be applied directly to the skin. This method of repellency may use a diluent to maintain the intensity of the repellant effect and reduce the cost of the composition.

### DETAILED DESCRIPTION OF THE INVENTION

The present invention comprises compositions for repelling insects comprising four or more essential oils or materials that can be extracted from essential oils, or a combination of essential oils and materials derived from essential oils. Such compositions do not require the addition of synergists or other such chemicals for effectiveness. An advantage of the present invention is that a composition may contain naturally derived materials.

Various insect repellent compositions comprising essential oils are contemplated by the present invention. A composition may comprise four or more essential oils, or four or more materials derived from essential oils, or four or more of a combination of essential oils and materials derived from essential oils, all of which may be referred to herein as an insect repellent. The insect repellent may be of natural or synthetic origin. Additionally, the composition can comprise other optional ingredients. These optional ingredients include colorants like dyes and pigments, fragrances, other oils, gellants, stabilizers, synergists, solvents, solubilizers and surfactants.

Preferred insect repellents are chosen from the following list of essential oils and chemicals including, but not limited to, cedarwood oil, citronella, citronella oil, citral, geraniol, geranium oil, lemongrass oil, and mint oil. The definition of mint oil includes one or more of the following mint oils including commint, peppermint, spearmint, mentha citral oil, pennyroyal oil and any other essential oil that may be considered part of the mint family. Some of these essential oils have been suggested to have insect repellency in aromatherapy and alternative treatment literature. Controlled testing has not shown that this is true in recent published reports. Recent published testing of single essential oils has shown that they are not effective in repelling insects. There has been no well controlled testing done that shows substantial insect repellency using single essential oils. The present invention overcomes the ineffective use of a single essential oil by combining several essential oils into a novel, effective composition for insect repellency.

An advantage of the present invention is the natural basis of the insect repellant. All of the components of the composition of the present invention can be derived from natural sources.

Various compositions of the present invention are described in Example 1. All of these examples are stable solutions. All of these examples are clear solutions. Both geraniol and citronella may be extracted from essential oils, and are thus, materials derived from essential oils. Geraniol may be extracted from palmarosa oil or geraniol. Citronella may be extracted from citronella oil. These extractions are generally performed using specific cuts or fractions from steam distillations although there are other methods to extract the materials from the essential oils.

The insect repellent compositions may be in a liquid, solid or semi-solid state. Suitable gels are described in U.S. Pat. No. 4,136,250, 4,362,841, 4,497,663, 5,645,845 and 5,780,527 each of which is incorporated in its entirety by reference herein. The gel can be of any composition wherein the insect repellant is released in an effective manner. The gel may be composed of materials that are not s reactive with the insect repellant.

The insect repellent compositions may in the liquid state. One preferred embodiment uses a system that minimizes the potential for spillage. This can be accomplished using wicks, blotters, sponges, porous ceramics, porous plastics and other adsorbent or absorbent methods or materials that will adsorb or absorb the repellent and allow its release over time.

The insect repellent can be used with an adsorbent or absorbent pad instead of incorporated into a gel. In one embodiment the pad is selected such that it does not melt at the elevated temperatures produced in certain embodiments described below. The adsorbent or absorbent pad can composed be any paper, sponge, cellulose, wood, non-woven or cloth that allows for the release of the insect repellant of the present invention in an effective manner.

A wick system may be used to disperse the composition using any porous medium that can allow the liquid to wick from a spill proof reservoir to an emanating surface from where the composition can then diffuse. Typical materials can be porous plastics, porous ceramics, non-wovens, cellulose materials, paper and porous glass.

Alternatively the repellant may be contained in a container and dispensed gradually or on demand to dispersing system that uses a liquid. This dispersing means may spray, atomize or evaporate the liquid to disperse it into the surrounding air.

A device for dispersing the compositions, or a dispersion means can be one or more means or one or more devices that cause the insect repellent to be dispersed into the air efficiently. The dispersion means or devices may act by effectively increasing the vapor pressure at the surface of the insect repellent composition. The dispersion means or devices may act by raising the energetic state of the molecules of the insect repellent thereby causing the molecules to be more easily released from the surface of the composition. Alternatively, the dispersion means or devices may physically cause dispersion by mechanical means. The dispersion means or devices may use the method of placing a charge onto the repellent molecules to cause them to disperse rapidly. The dispersion means or devices can be powered by any conventional power source including battery, solar cells, a mechanical generator and electricity from a standard electrical receptacle. Power can be generated by using a generator. The dispersion means or devices may comprise one or more of the following methods or components to disperse the insect repellent.

1. Heat Source. In one embodiment a heating element is placed within proximity of the insect repellent composition. By heating the composition to above ambient temperature, the vapor pressure of the insect repellent increases, allowing more of the repellent to be released into the surrounding air. In one embodiment the composition temperature is raised to about 120-140 degrees Fahrenheit. The heat may be provided by conduction or radiant means. In a preferred embodiment a resistance heating element is placed under the composition and allowed to heat the composition by conduction. This is especially suitable for gelled compositions. In a second embodiment a radiant source is placed in close proximity to the composition. Suitable radiant sources include resistance heaters, light sources and quartz heaters. In a preferred embodiment a radiant source directly above a liquid wick composition heats the top portion of the wick causing increased evaporation or the composition on the wick without heating the bulk of the liquid composition. One such convection heating system is the Glade® PlugIns® manufactured by the S.C. Johnson company.

In one preferred embodiment heat is generated by combusting a volatile liquid containing the insect repellant by a catalytic low temperature combustion on the surface of a porous ceramic emitter. The emitter also allows the diffusion of a portion of the insect repellant and the volatile liquid through the emitter into the surrounding air simultaneous to the combustion.

Other heat sources may also be used to disperse the composition of the present invention. Electrical diffusers such as the aforementioned Glade® PlugIns® manufactured by S.C. Johnson can be used. Non-electrical diffusers such as porous ceramic diffusers that are coated with a catalytic metal can also be used to diffuse the composition of the present invention. When activated these devices warm the porous ceramic using a low temperature catalytic combustion of an alcohol fuel which contains the insect repellent. The preferred concentration of the composition in the fuel should be between about 0.1 and 5.0%. The heat source can be from the flame of a candle. When lit, the candle melt pool will allow for evaporation of the insect repellent from the surface. The preferred composition concentration of the present invention within the candle should be between about 0.5-25%.

2. Fan Dispersion. In one embodiment a fan can be placed such that the fan blows over the surface or in close proximity to the surface of the composition. The blowing action of the fan causes air to sweep across the composition causing the insect repellent that has vaporized to be swept away from the surface. This action allows for increased amounts of repellent to be dispersed into the surrounding air.

In a preferred embodiment of the invention the fan oscillates allowing the dispersion of repellent in several directions. In another embodiment multiple fans direct the repellent into several directions simultaneously.

3. Heat and Fan. In a preferred embodiment both heat and a fan are utilized to provide a rapid efficient dispersion means. One such combination dispersion means is available from Envirodine Studios (Canton, Ga., USA). Heat may be provided by convection, radiant or conduction means. It is possible to produce heat using the fan. This is described in U.S. Pat. No. 6,361,752 and is incorporated in its entirety by reference herein.

4. Electospray. In one embodiment an electrostatic sprayer such as that described in U.S. Pat. No. 4,659,012 is used to disperse the repellent. The liquid repellent composition is placed into the device, said devices causing a charge to be associated with the repellent, said charge causing a rapid dispersion of the repellent.

5. Atomizer. Atomizer dispersion devices can be used in the present invention. These devices break a liquid composition into small droplets that are expelled into the air by a pump. The devices are typically used without heat. One such atomizer is marketed by Young Living Oils (Salt Lake City, Utah, USA).

6. Bubble-jet. The insect repellent composition can be dispersed using a bubble-jet type device. This device is described in U.S. patent application number 2002/0192255 and is incorporated by reference herein. The device expels very small droplets of the repellent into the surrounding air. 7. Piezoelectric. The use of a piezoelectric device to disperse the insect repellent composition requires the composition to be in the liquid state. This dispersion means or device is well described in U.S. Pat. Nos. 6,293,474 and 6,296,196 and is incorporated by reference herein. The compositions in Example 1 were mixed and all were stable and homogeneous after mixing. Approximately 20 grams of composition D was gelled and placed into the ES-1 dispersion device manufactured by Envirodine Studios (Canton Ga., USA). The ES-1 contains means for heating the composition to 130F while in the direct path of a dispersing fan. The ES-1 containing the composition D was placed outside in mid summer at 8:00 p.m. On alternating evenings the device was left off or turned on. During the evenings when the device was left off an average of 7 mosquito landings were recorded during an average 30 minute time period. During evenings when the device was turned on less than one landing during an average 30 minute time period was observed.

The present invention may be placed on the skin to provide effective insect repellency. Example 1 describes compositions that are suitable for use on skin. Carriers and diluents may be included to reduce cost, odor, and still maintain good repellency. The presence of soybean oil at a level up to about 95% may be included in the skin repellant composition.

### EXAMPLES

### Example 1

Compositions of essential oils and essential oil derived materials were mixed and found to be homogeneous mixtures. See Table 1.

TABLE 1
Weight Percent

| Ingredient | A | B | C | D | E | F | G | H |
|---|---|---|---|---|---|---|---|---|
| Citronella | 25 | 25 | 25 | 19 | 15 | | 20 | 20 |
| Oil | | | | | | | | |
| Citronella | 25 | | | | | 18 | | |
| Geranium | 25 | 25 | | | | | | |
| Oil | | | | | | | | |
| Gerianiol | 25 | | 25 | 22 | 15 | 34 | 20 | 25 |
| Cerdarwood | | | | | 40 | | | 35 |
| Oil | | | | | | | | |
| Mint | | | 25 | 51 | 25 | 26 | 15 | 12 |
| Oil | | | | | | | | |
| Lemongrass | | | 25 | 8 | | | 10 | 8 |
| Oil | | | | | | | | |
| Peppermint | | 25 | | | | | 35 | |
| Oil | | | | | | | | |
| Citral | | 25 | | | 5 | 22 | | |
| Total | 100 | 100 | 100 | 100 | 100 | 100 | 100 | 100 |

What is claimed is:

1. A composition for repelling insects, comprising, four or more essential oils or materials that can be extracted from essential oils.

2. The composition of claim 1, wherein the composition comprises four or more of Citral, Citronella, Citronella Oil, Mint Oil, Commint Oil, Peppermint Oil, Mentha citrate Oil, Lemongrass Oil, Cedarwood Oil, Geraniol, or Geranium Oil.

3. The composition of claim 1, wherein an odorant is included in the composition.

4. The composition of claim 3, wherein the odorant is a fragrance.

5. The composition of claim 1, wherein the composition is contained in a gel.

6. The composition of claim 1, wherein the composition is placed on an adsorbent material.

7. The composition of claim 1, wherein the composition is placed on an absorbent material.

8. The composition of claim 1, wherein the composition comprises at least citronella oil, geraniol, lemongrass oil, and commint oil.

9. The composition of claim 1, wherein the composition contains at least citronella oil, geranium oil, lemongrass oil and mint oil.

10. The composition of claim 1, wherein the composition is diluted with a diluent up to about 95% by weight.

11. The composition of claim 10, wherein the diluent is soybean oil.

12. A method for repelling insects, comprising,
a) placing an insect repelling composition into an active diffusion device; and
b) diffusing the composition;
wherein the insect repelling composition comprises four or more of Citral, Citronella, Citronella Oil, Mint Oil, Commint Oil, Peppermint Oil, Mentha citrate Oil, Lemongrass Oil, Cedarwood Oil, Geraniol, or Geranium Oil.

13. The method of claim 12, wherein the active diffusion device comprises one or more of a heat source, a fan, an electrospray, an atomizer, a bubble jet emanator, or a piezoelectric disperser.

14. The method of claim 12, wherein diffusing the insect repelling composition comprises using a heat source and a fan.

15. The method of claim 12, wherein the heat source is a catalytic porous emitter.

16. The method of claim 12, wherein the heat source is a candle flame.

17. A composition to repel insects, comprising at least one material from each of:
(1) citronella or citronella oil,
(2) geraniol or geranium oil
(3) lemongrass oil or citral; and
(4) mint oil, mentha citrate oil, commint oil or peppermint oil.

18. The composition of claim 17, further comprising cedarwood oil.

19. The composition of claim 17, wherein citronella or citronella oil is present in an amount of from about 18 percent to about 25 percent by weight, geraniol or geranium oil is present in an amount of from about 15 percent to about 34 percent by weight, lemongrass oil or citral is present in an amount of from about 5 percent to about 25 percent by weight, and mint oil or peppermint oil is present in an amount of from about 12 percent to about 51 percent by weight.
